(19) United States
(12) Patent Application Publication
(10) Pub. No.: US 2017/0150520 A1
(43) Pub. Date: May 25, 2017

(54) Controlling Access to a Radio Medium for Wireless Communication

(71) Applicant: TELEFONAKTIEBOLAGET LM ERICSSON (PUBL), Stockholm (SE)

(72) Inventors: Johan Söder, Hägersten (SE); Filip Mestanov, Sollentuna (SE); Soma Tayamon, Stockholm (SE); Yu Wang, Solna (SE); Gustav Wikström, Kista (SE)

(21) Appl. No.: 14/649,017

(22) PCT Filed: Apr. 23, 2015
(86) PCT No.: PCT/SE2015/050458

§ 371 Date: Jun. 2, 2015

(51) Int. Cl. H04W 74/00; H04W 74/08

(52) U.S. Cl. CPC H04W 74/002; H04W 74/0808; H04W 88/08

(57) ABSTRACT

According to one aspect, there is provided a method for controlling access to a radio medium. The method comprises deciding (S1), in response to a Request-To-Send, RTS, message from a wireless communication device, whether the wireless communication device is to be allowed or denied access for transmission on the radio medium. The method also comprises (S2) sending, if access to the radio medium is denied, a negative Clear-To-Send, CTS, message to the wireless communication device instructing the wireless communication device to temporarily refrain from accessing the radio medium for transmission during a refrain time interval.

### TECHNICAL FIELD

The proposed technology generally relates to wireless communication systems and especially to methods for controlling access to a radio medium, arrangements configured to control access to a radio medium, corresponding network node(s) and/or wireless communication device(s), corresponding computer programs and computer program carriers, as well as apparatuses for controlling access to a radio medium.

### BACKGROUND

In general, medium access is of outmost importance for the operation and performance of communication networks.

A contention-based protocol is a communication protocol for medium access and for operating communication equipment that allows many users to use the same transmission medium such as a radio medium with little or no pre-coordination.

Listen Before Talk, LBT, or sometimes called Listen Before Transmit is an example of a contention-based procedure for medium access used in radio communications whereby a radio transmitter first senses its radio environment, i.e. a radio medium or channel, before it starts a transmission. Sometimes Listen Before Talk is referred to as Sense Before Transmit. The LBT operating procedure in IEEE 820.11 for Wireless Local Area Networks, WLANs, is one of the most well-known contention-based protocols.

For example, Carrier Sensing Multiple Access, CSMA, is a Medium Access Control, MAC, protocol in which a node verifies the absence of other traffic before transmitting on a shared transmission medium, such as an electrical bus, or a band of the electromagnetic spectrum.

Carrier Sensing means that a transmitter uses feedback from a receiver to determine whether another transmission is in progress before initiating a transmission. That is, the transmitter tries to detect the presence of a transmission or carrier wave from another station before attempting to transmit. If a transmission/carrier is sensed, the station waits for the transmission in progress to finish before initiating its own transmission. In other words, CSMA is also based on LBT. Multiple access means that multiple stations send and/or receive on the medium.

In Wireless Local Area Networks, WLAN, systems, the concept of a Request-To-Send, RTS, and a Clear-To-Send, CTS, message handshake between a receiver and a transmitter was introduced as an additional overlay to carrier sensing in order to eliminate so-called hidden node problems. In general, a station intending to transmit on the uplink will send an RTS frame to the AP, which in turn replies with a CTS frame. Nodes not involved in the RTS-CTS frame exchange, but that hear the RTS and/or the CTS will refrain from using the channel during the time period of the upcoming data frame exchange.

Wireless networks using carrier sensing as a basis for medium access however typically suffer from low spectral efficiency and/or low spatial reuse in dense deployments. This is due to the fact that stations, STAs, and access points, APs, must back-off, from accessing the wireless medium if they sense that the medium is busy. To increase the spatial reuse, the medium sensing thresholds may be tuned to be more aggressive. However, this may lead to high interference situations, leading to reduced system performance and impaired user experience.

### SUMMARY

It is an object to provide improved medium access control in wireless communication systems from the network side and/or terminal side.

It is also an object to provide methods for controlling access to a radio medium.

Another object is to provide arrangements configured to control access to a radio medium.

It is also an object to provide a network node comprising an arrangement configured to control access to a radio medium.

Yet another object is to provide a wireless communication device comprising an arrangement configured to control access to a radio medium.

It is a specific object to provide a network node configured to control access to a radio medium.

Still another object is to provide corresponding computer programs and computer program carriers.

It is also an object to provide various apparatuses for controlling access to a radio medium.

These and other objects are met by embodiments of the proposed technology.

According to a first aspect, there is provided a method for controlling access to a radio medium. The method comprises deciding, in response to a Request-To-Send, RTS, message from a wireless communication device, whether the wireless communication device is to be allowed or denied access for transmission on the radio medium. The method also comprises sending, if access to the radio medium is denied, a negative Clear-To-Send, CTS, message to the wireless communication device instructing the wireless communication device to temporarily refrain from accessing the radio medium for transmission during a refrain time interval.

According to a second aspect, there is provided a method for controlling access to a radio medium. The method comprises receiving, in response to a Request-To-Send, RTS, message, a negative Clear-To-Send, CTS, message from an access point. The method also comprises temporarily refraining, in response to the negative CTS message, from accessing the radio medium for transmission during a refrain time interval.

According to a third aspect, there is provided a method for controlling access to a radio medium. The method comprises providing access to the radio medium for downlink transmissions in dedicated downlink transmission time period(s) and for uplink transmissions in dedicated uplink transmission time period(s). The method also comprises sending, in response to a Request-To-Send, RTS, message received from a wireless communication device during a downlink transmission time period, a negative Clear-To-Send, CTS, message to the wireless communication device instructing the wireless communication device to refrain from accessing the radio medium for transmission during a time interval lasting at least until the expiration of the downlink transmission time period.

According to a fourth aspect, there is provided an arrangement configured to control access to a radio medium. The arrangement is configured to decide, in response to a Request-To-Send, RTS, message from a wireless communication device, whether the wireless communication device is to be allowed or denied access for transmission on the radio medium. The arrangement is also configured to send, if access to the radio medium is denied, a negative Clear-To-Send, CTS, message to the wireless communication device instructing the wireless communication device to temporarily refrain from accessing the radio medium for transmission during a refrain time interval.

According to a fifth aspect, there is provided a network node comprising such an arrangement.

According to a sixth aspect, there is provided an arrangement configured to control access to a radio medium. The arrangement is configured to receive, in response to a Request-To-Send, RTS, message, a negative Clear-To-Send, CTS, message from an access point. The arrangement is also configured to temporarily refrain, in response to the negative CTS message, from accessing the radio medium for transmission during a refrain time interval.

According to a seventh aspect, there is provided a wireless communication device comprising such an arrangement.

According to an eighth aspect, there is provided a network node configured to control access to a radio medium. The network node is configured to provide access to the radio medium for downlink transmissions in dedicated downlink transmission time period(s) and for uplink transmissions in dedicated uplink transmission time period(s). The network node is also configured to send, in response to a Request-To-Send, RTS, message received from a wireless communication device during a downlink transmission time period, a negative Clear-To-Send, CTS, message to the wireless communication device instructing the wireless communication device to refrain from accessing the radio medium for transmission during a time interval lasting at least until the expiration of the downlink transmission time period.

According to a ninth aspect, there is provided a computer program comprising instructions, which when executed by at least one processor, cause the at least one processor to:
decide, in response to a Request-To-Send, RTS, message originating from a wireless communication device, whether the wireless communication device is to be allowed or denied access for transmission on a radio medium; and
generate, if access to the radio medium is denied, a negative Clear-To-Send, CTS, message for sending to the wireless communication device instructing the wireless communication device to temporarily refrain from accessing the radio medium for transmission during a refrain time interval.

According to a tenth aspect, there is provided a computer program comprising instructions, which when executed by at least one processor, cause the at least one processor to:
read a negative Clear-To-Send, CTS, message originating from an access point; and
instruct, in response to the negative CTS message, a communication unit to temporarily refrain from accessing the radio medium for transmission during a refrain time interval.

According to an eleventh aspect, there is provided a computer program comprising instructions, which when executed by at least one processor, cause the at least one processor to:
control access to the radio medium for downlink transmissions in dedicated downlink transmission time period(s) and for uplink transmissions in dedicated uplink transmission time period(s);
generate, in response to a Request-To-Send, RTS, message received from a wireless communication device during a downlink transmission time period, a negative Clear-To-Send, CTS, message for transmission to the wireless communication device instructing the wireless communication device to refrain from accessing the radio medium for transmission during a time interval lasting at least until the expiration of the downlink transmission time period.

According to a twelfth aspect, there is provided a carrier comprising any of the above computer programs, wherein the carrier is one of an electronic signal, an optical signal, an electromagnetic signal, a magnetic signal, an electric signal, a radio signal, a microwave signal, or a computer-readable storage medium.

According to a thirteenth aspect, there is provided an apparatus for controlling access to a radio medium. The apparatus comprises a decision module for deciding, in response to a Request-To-Send, RTS, message originating from a wireless communication device, whether the wireless communication device is to be allowed or denied access for transmission on a radio medium. The apparatus also comprises a message generating module for generating, if access to the radio medium is denied, a negative Clear-To-Send, CTS, message. The apparatus further comprises an output module for outputting the negative CTS message for transmission to the wireless communication device instructing the wireless communication device to temporarily refrain from accessing the radio medium for transmission during a refrain time interval.

According to a fourteenth aspect, there is provided an apparatus for controlling access to a radio medium. The apparatus comprises an input module for reading a negative Clear-To-Send, CTS, message originating from an access point. The apparatus also comprises a control module for instructing, in response to the negative CTS message, a communication unit to temporarily refrain from accessing the radio medium for transmission during a refrain time interval.

According to a fifteenth aspect, there is provided an apparatus for controlling access to a radio medium. The apparatus comprises a medium access control module for controlling access to the radio medium for downlink transmissions in dedicated downlink transmission time period(s) and for uplink transmissions in dedicated uplink transmission time period(s). The apparatus also comprises a message generating module for generating, in response to a Request-To-Send, RTS, message received from a wireless communication device during a downlink transmission time period, a negative Clear-To-Send, CTS, message. The apparatus further comprises an output module for outputting the negative CTS message for transmission to the wireless communication device instructing the wireless communication device to refrain from accessing the radio medium for transmission during a time interval lasting at least until the expiration of the downlink transmission time period.

An example of an advantage of the proposed technology is that the negative CTS is a direct way to inform a wireless communication device that is requesting access to the radio medium to temporarily refrain from accessing the medium during a specified period of time. For example, this may give a network node such as an access point better control over the medium access, which in turn may lead to improved system performance and/or improved user experience.

Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic flow diagram illustrating an example of a method for controlling access to a radio medium according to an embodiment.

FIG. 2 is a schematic diagram illustrating an example of a method for controlling access to a radio medium according to another embodiment.

FIG. 3 is a schematic diagram illustrating an example of a method for controlling access to a radio medium according to yet another embodiment.

FIG. 4 is a schematic signaling diagram illustrating an example of the signaling and actions performed by an access point and an associated wireless device according to an embodiment.

FIG. 5 is a schematic diagram illustrating an example of two access points involved in simultaneous uplink and downlink transmissions causing strong interference.

FIGS. 6A-B are schematic diagrams illustrating an example of two access points operating in time-alignment based on common and dedicated downlink transmission time period(s) and uplink transmission time period(s), respectively to provide a separation between downlink and uplink transmissions.

FIG. 7 is a schematic diagram illustrating an example of the general basic RTS/CTS procedure.

FIG. 8 is a schematic flow diagram illustrating a non-limiting example of a method for controlling access to a radio medium from the network side according to a specific embodiment.

FIG. 9 is a schematic flow diagram illustrating a non-limiting example of a method for controlling access to a radio medium from the terminal side according to a specific embodiment.

FIG. 10 is a schematic flow diagram illustrating a non-limiting example of a method for controlling access to a radio medium from the terminal side according to another specific embodiment.

FIG. 11 is a schematic block diagram illustrating an example of an arrangement configured to control access to a radio medium according to an embodiment.

FIG. 12 is a schematic diagram illustrating an example of a network node comprising an arrangement of FIG. 11.

FIG. 13 is a schematic block diagram illustrating an example of an arrangement configured to control access to a radio medium according to another embodiment.

FIG. 14 is a schematic diagram illustrating an example of a wireless communication device comprising an arrangement of FIG. 13.

FIG. 15 is a schematic diagram illustrating an example of a computer implementation according to an embodiment.

FIGS. 16A-C are schematic computer flow diagrams illustrating examples of respective series of computer-implemented actions.

FIG. 17 is a schematic diagram illustrating an example of an apparatus for controlling access to a radio medium according to an embodiment.

FIG. 18 is a schematic diagram illustrating an example of an apparatus for controlling access to a radio medium according to another embodiment.

FIG. 19 is a schematic diagram illustrating an example of an apparatus for controlling access to a radio medium according to yet another embodiment.

### DETAILED DESCRIPTION

Throughout the drawings, the same reference designations are used for similar or corresponding elements.

The inventors have recognized that the system performance can be improved if the network side is given more control over the medium access, also referred to as channel access.

The proposed technology introduces a so-called negative Clear-To-Send, CTS, message as a direct way to inform a wireless communication device that is requesting access to the radio medium to temporarily refrain from accessing the medium during a specified period of time. For example, this may give a network node such as an access point better control over the medium access, which in turn may lead to improved system performance and/or improved user experience, as will be exemplified later on. The radio medium is sometimes interchangeably denoted as a wireless transmission medium or simply a wireless medium.

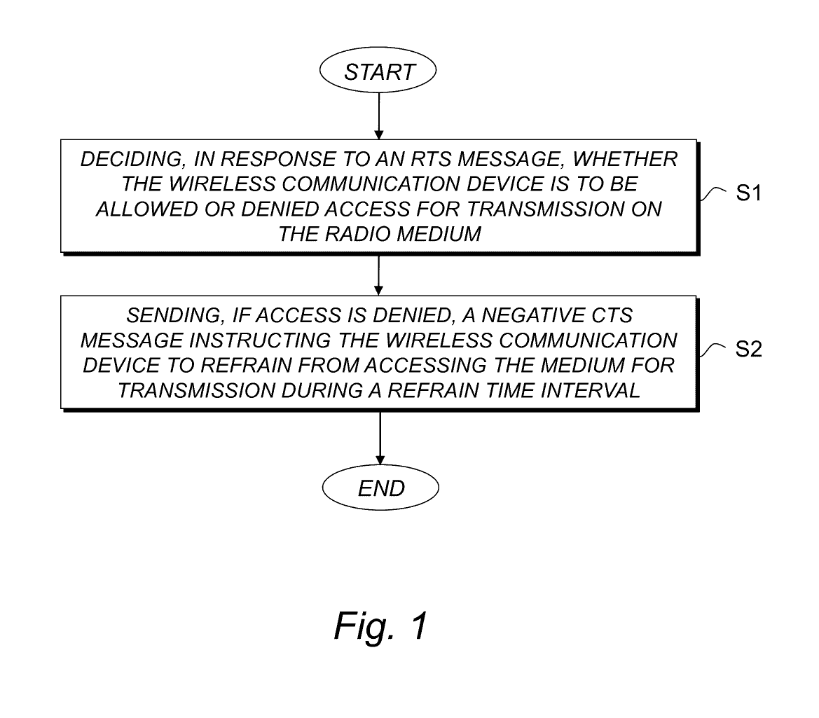

FIG. 1 is a schematic flow diagram illustrating an example of a method for controlling access to a radio medium according to an embodiment. The method basically comprises the following steps:

S1: deciding, in response to a Request-To-Send, RTS, message from a wireless communication device, whether the wireless communication device is to be allowed or denied (at least temporarily) access for transmission on the radio medium; and

S2: sending, if access to the radio medium is denied, a negative Clear-To-Send, CTS, message to the wireless communication device instructing the wireless communication device to temporarily refrain from accessing the radio medium for transmission during a refrain time interval.

The negative CTS message may also be denoted as an nCTS message or simply nCTS, and all these notations will and can be used interchangeably. The term negative CTS frame is sometimes also used interchangeably with the term negative CTS message. Other possible notations are indicated later on.

The RTS message is a control message for requesting access to the radio medium for transmission, and the negative CTS message is a control message for instructing the wireless communication device to temporarily refrain from accessing the radio medium.

In general, the refrain time interval is a non-zero time interval so as to cause the wireless communication device to temporarily refrain from accessing the radio medium for transmission during a real time interval that lasts for a specified period of time.

Optionally, the negative CTS message also includes information about the duration of refrain time interval.

By way of example, the negative CTS message may optionally also include information representing a reason for denying access for transmission on the radio medium and/or information of when and how the wireless device may access the channel.

As an example, the negative CTS message may include information instructing the wireless communication device to contend for the medium and send a new RTS message after expiration of the refrain time interval.

Alternatively, the negative CTS message may include information instructing the wireless communication device to perform an uplink data transmission at expiration of the refrain time interval.

In a particular example, the negative CTS message is represented by a CTS message with the Network Allocation Vector, NAV, field set to zero.

Legacy stations overhearing a CTS message with NAV set to zero will not reset the NAV, since stations shall update its NAV only when the received value is greater than the station's current NAV value. Thus, the nCTS implementation using a CTS with NAV set to zero will be entirely transparent to legacy stations.

The proposed technology may for example improve air efficiency and/or user experience in a wireless communication systems such as a WLAN by introducing a mechanism that helps the network side, such as an access point, AP, deny or at least delay uplink transmissions.

For example, by doing so the access point may align downlink and uplink periods with neighboring access points, thus avoiding heavy interference from uplink transmitters to downlink receivers. The access point may also have other reasons for steering the traffic, for instance when handling data with higher priority, or trying to achieve fairness in the system, or if the access point is experiencing a period of high external interference which would make reception difficult, or if the access point has knowledge from coordination with other access points.

By way of example, the step of deciding whether the wireless communication device is to be allowed or denied access for transmission on the radio medium may be based on determining whether the RTS message is received during a downlink transmission time period. The downlink transmission time period is dedicated for downlink transmissions by at least one access point, and access to the radio medium for transmission by the wireless communication device is typically denied during the downlink transmission time period.

Normally, the downlink transmission time period is common for at least two neighboring access points.

As an example, the downlink transmission time period may be determined based on negotiation between access points or by a network unit controlling the access points.

For example, the refrain time interval is a count-down time lasting until the expiration of the downlink transmission time period.

By way of example, the step of deciding whether the wireless communication device is to be allowed or denied access for transmission on the radio medium may be based on at least one of the following:
information about dedicated downlink transmission period(s);
information on the traffic type of the transmission;
fairness information; and
information about the interference situation in the area of the wireless communication device.

In a particular example, the step of deciding whether the wireless communication device is to be allowed or denied access for transmission depends at least partly on whether the amount of data in a data buffer for downlink transmissions exceeds a threshold, to enable fairness between uplink and downlink transmissions.

In another particular example, the step of deciding whether the wireless communication device is to be allowed or denied access for transmission depends at least partly on whether the wireless communication device has a higher usage of the radio medium than other wireless communication device(s), to enable fairness between different wireless communication devices for uplink transmissions.

As understood, the method described above in connection with FIG. 1 may be performed on the network side. For example, the method may be performed by an access point or equivalent network node.

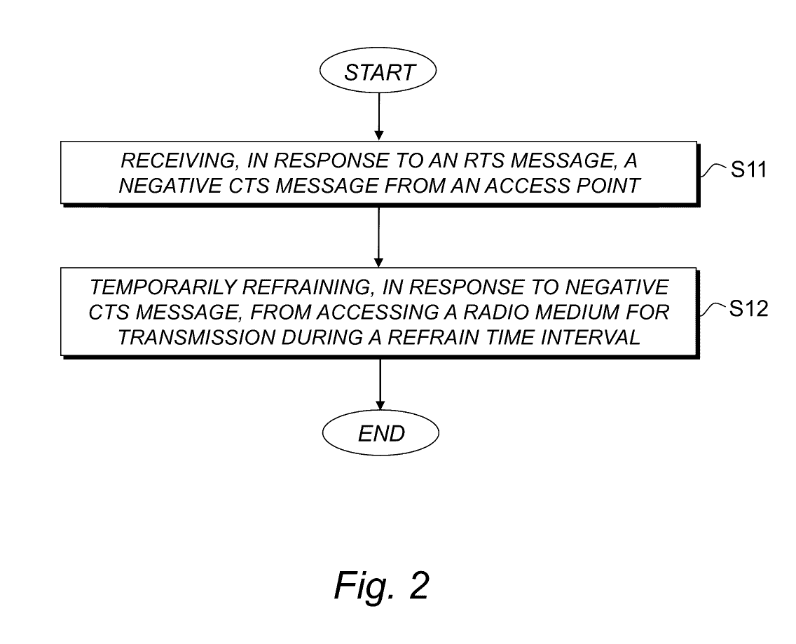

FIG. 2 is a schematic diagram illustrating an example of a method for controlling access to a radio medium according to another embodiment. The method basically comprises the following steps:

S11: receiving, in response to a Request-To-Send, RTS, message, a negative Clear-To-Send, CTS, message from an access point; and

S12: temporarily refraining, in response to the negative CTS message, from accessing the radio medium for transmission during a refrain time interval.

Optionally, the negative CTS message also includes information about the duration of the refrain time interval.

By way of example, the negative CTS message may include information representing a reason for denying access for transmission on the radio medium and/or information of when and how the wireless device may access the channel.

As an example, the negative CTS message may include information instructing the wireless communication device to contend for the medium and send a new RTS message after expiration of the refrain time interval. Accordingly, the method further comprises the steps of contending for the medium and sending a new RTS message after expiration of the refrain time interval.

Alternatively, the negative CTS message also includes information instructing the wireless communication device to perform an uplink data transmission at expiration of the refrain time interval. Accordingly, the method further comprises the step of performing the uplink data transmission at expiration of the refrain time interval.

In a particular example, the negative CTS message may be represented by a CTS message with the Network Allocation Vector, NAV, field set to zero.

In another example, the refrain time interval is a count-down time lasting until the expiration of a downlink transmission time period dedicated for downlink transmissions by at least one access point.

As understood the method described above in connection with FIG. 2 may be performed on the terminal side. For example, the method may be performed by a wireless communication device such as a User Equipment, UE, or a WLAN station, STA.

As indicated, the refrain time interval may e.g. be preconfigured and maintained as a value in memory for easy access, or signaled to the wireless device. The time interval is a non-zero time interval.

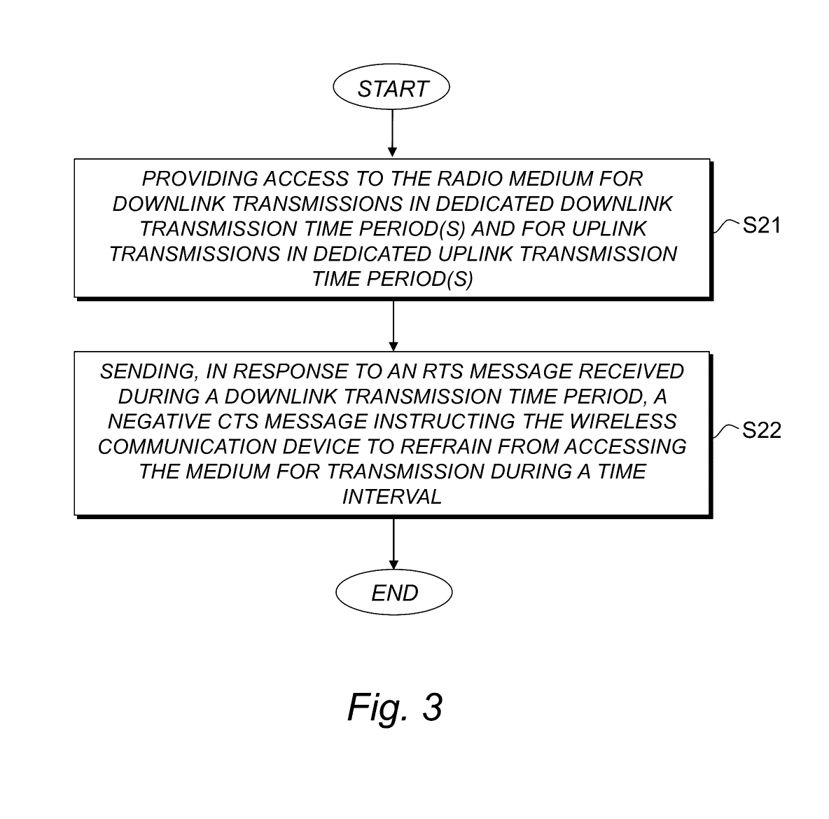

FIG. 3 is a schematic diagram illustrating an example of a method for controlling access to a radio medium according to yet another embodiment. The method basically comprises the following steps:

S21: providing access to the radio medium for downlink transmissions in dedicated downlink transmission time period(s) and for uplink transmissions in dedicated uplink transmission time period(s); and

S22: sending, in response to a Request-To-Send, RTS, message received from a wireless communication device during a downlink transmission time period, a negative Clear-To-Send, CTS, message to the wireless communication device instructing the wireless communication device to refrain from accessing the radio medium for transmission during a time interval lasting at least until the expiration of the downlink transmission time period.

In this way, downlink transmissions and uplink transmissions can be separated in time, and downlink transmissions and uplink transmissions in neighboring access points or base station systems can be aligned to avoid high interference situations, e.g. in the case of aggressive CSMA/CA settings.

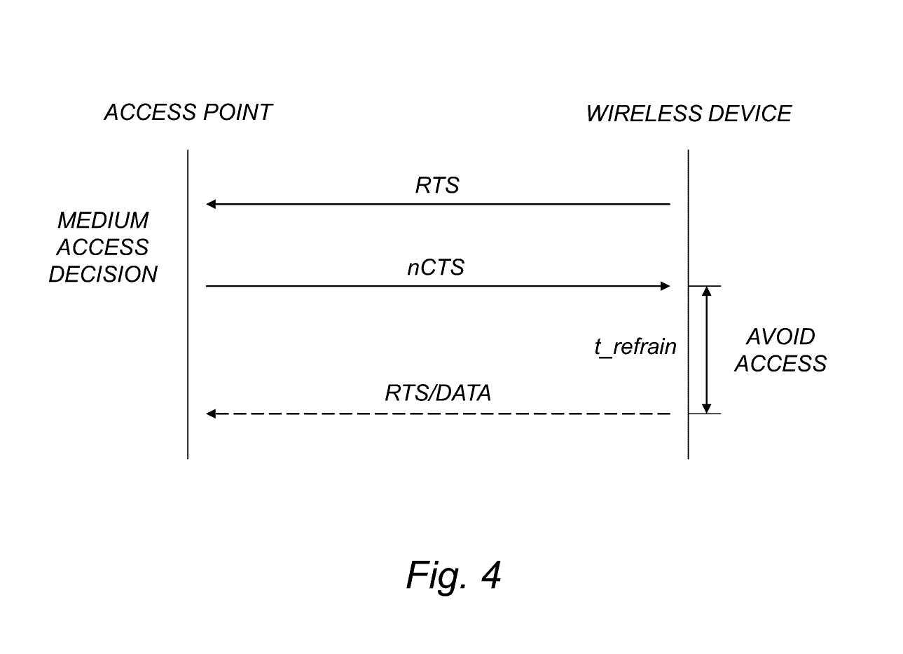

FIG. 4 is a schematic signaling diagram illustrating an example of the signaling and actions performed by an access point and an associated wireless device according to an embodiment.

A wireless device sends a RTS message, after sensing that the medium is free based on a clear assessment threshold or equivalent channel or medium sensing threshold.

The access point receives the RTS message.

In the conventional protocol, the access point merely responds with a CTS message as part of a handshake procedure with the wireless device.

However, according to the proposed technology, the access point takes a medium access decision in response to the RTS message.

If the decision is to deny access for the wireless device, the access point sends a nCTS message to the wireless device.

If the decision is to allow access for the wireless device, the access point sends a CTS message to the wireless device according to the normal handshake procedure.

In response to a received nCTS message, the wireless device refrains from accessing the medium during a specified time interval, t_refrain.

After expiry of the specified time interval, the wireless device may contend for the access to the medium again and send a new RTS, or send the pending data DATA, as indicated by the dashed line at the end of the signaling exchange.

For a better understanding of the proposed technology, it may be useful with a brief overview and analysis with reference to the particular non-limiting context of a Wireless Local Area Network, WLAN.

The WLAN technology is a general technology for local wireless communications. As the name implies Wireless Local Area Network, WLAN, technology offers a basis for wireless communications within a local area coverage. The WLAN technology includes industry-specific solutions as well as proprietary protocols, although most commercial applications are based on well-accepted standards such as the various versions of IEEE 802.11, also popularly referred to as Wi-Fi.

WLAN is standardized in the IEEE 802.11 specifications such as IEEE Standard for Information technology—Tele-communications and information exchange between systems. Local and metropolitan area networks—Specific requirements. Part 11: Wireless LAN Medium Access Control (MAC) and Physical Layer (PHY) Specifications). WLAN systems following the 802.11 MAC specifications operate based on distributed medium or channel access, meaning that each node in the network has more or less equal probability of accessing the medium.

WLAN or Wi-Fi currently mainly operates on the 2.4 GHz or the 5 GHz band. The IEEE 802.11 specifications regulate the access points' or wireless terminals' physical layer, MAC layer and other aspects to secure compatibility and inter-operability between access points, also referred to as APs, and wireless devices or terminals, also referred to as STAs. Wi-Fi is generally operated in unlicensed bands, and as such, communication over Wi-Fi may be subject to interference sources from any number of both known and unknown devices. Wi-Fi is commonly used as wireless extensions to fixed broadband access, e.g., in domestic environments and hotspots, like airports, train stations and restaurants.

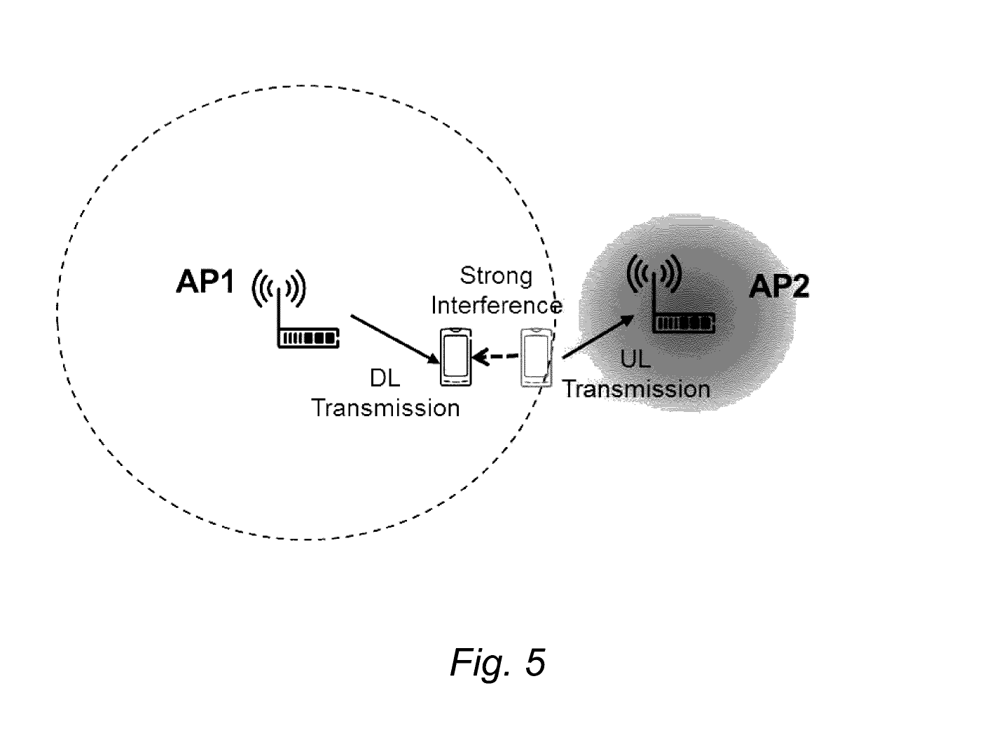

For 802.11 WLAN systems operating in dynamic Time Division Duplex, TDD, mode, there is no distinction between downlink, DL, and uplink, UL, transmissions, which may lead to strong interference between neighbor Basic Service Sets, BSSs, in the case of an UL transmission in one BSS and a simultaneous DL transmission in a neighbor BSS. If the two stations involved in data exchange in the different BSSs are close to each other, the station transmitting in UL will create heavy interference to the station trying to receive a DL transmission in the neighbor BSS, as illustrated in FIG. 5. This is typically resolved through the LBT type of medium access used by WLAN systems, e.g. CSMA/CA. However, this protocol leads to low spatial reuse of the wireless medium in dense deployments. It may thus be beneficial to tune the listening thresholds in the CSMA/CA protocol to be much more aggressive, which may in turn lead to the strong interference situation described above.

For this particular example, the proposed technology introduces a means of aligning the UL and DL transmissions in the neighbor BSS's to avoid the high interference situation in the case of very aggressive CSMA/CA settings or other means to reach higher spatial reuse in a WLAN system.

More generally, the proposed technology introduces the concept of a negative clear-to-send message, i.e. a negative CTS or nCTS. A station or equivalent wireless communication device receiving a negative CTS should refrain from accessing the channel, and preferably also from sending a new request-to-send, RTS, for a predefined time interval.

A way of reaching high spectrum efficiency in dense deployments is to operate systems in reuse 1, e.g. as the 3GPP LTE system does. Reuse 1 means that neighboring cells/BSSs operate independently of each other, and may have ongoing transmissions simultaneously. This does however require a separation of DL and UL transmissions, to avoid the problem depicted in FIG. 5.

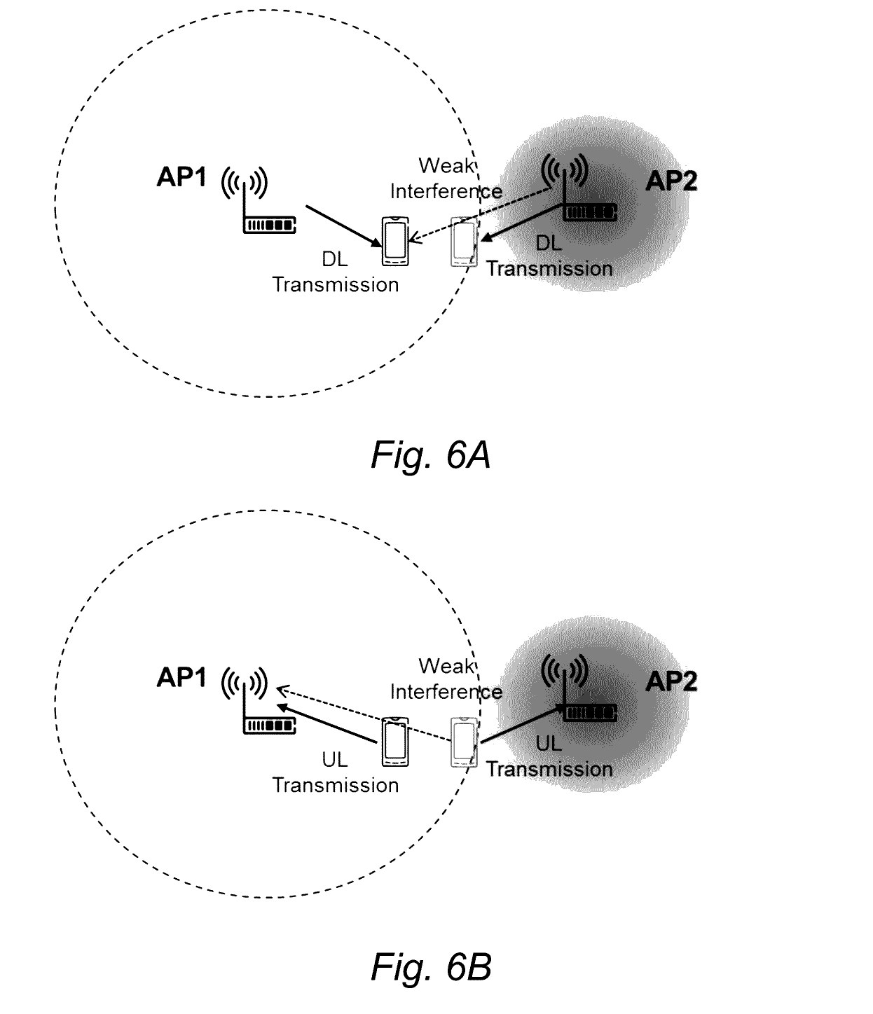

FIGS. 6A-B are schematic diagrams illustrating an example of two access points operating in time-alignment based on common and dedicated downlink transmission time period(s) and uplink transmission time period(s), respectively to provide a separation between downlink and uplink transmissions.

Separation of DL and UL transmissions may be achieved either in the frequency or in the time domain. Since 802.11 WLAN operates in TDD mode achieving DL and UL separation in time domain may be achieved by small modifications to the existing specifications. Separating UL and DL transmission in time domain may be done for instance by the APs or equivalent network nodes agreeing on common DL and UL periods. This may be done through communication directly between the APs, over the wireless medium or over another interface, e.g. direct cabling or over the internet or through a central node in the network. The decision on the UL and DL periods may also be taken by a central node, e.g. an Access Controller, AC, and communicated to the APs. Once the DL and UL periods are known to all the concerned APs, the problem is for each AP to stop the associated from initiating UL transmissions during the DL period. The proposed solution involves the introduction of a negative CTS frame.

For DL, it is feasible to ensure that DL periods are fully utilized since the APs are aware of the DL periods and can use much higher channel sensing thresholds, ignoring concurrent transmission in neighbor BSSs. For the UL, the stations should be more aggressive to fully utilize the UL periods. By using the negative CTS, the stations may have very aggressive sensing thresholds all the time, as long as they are requesting access through RTS/CTS.

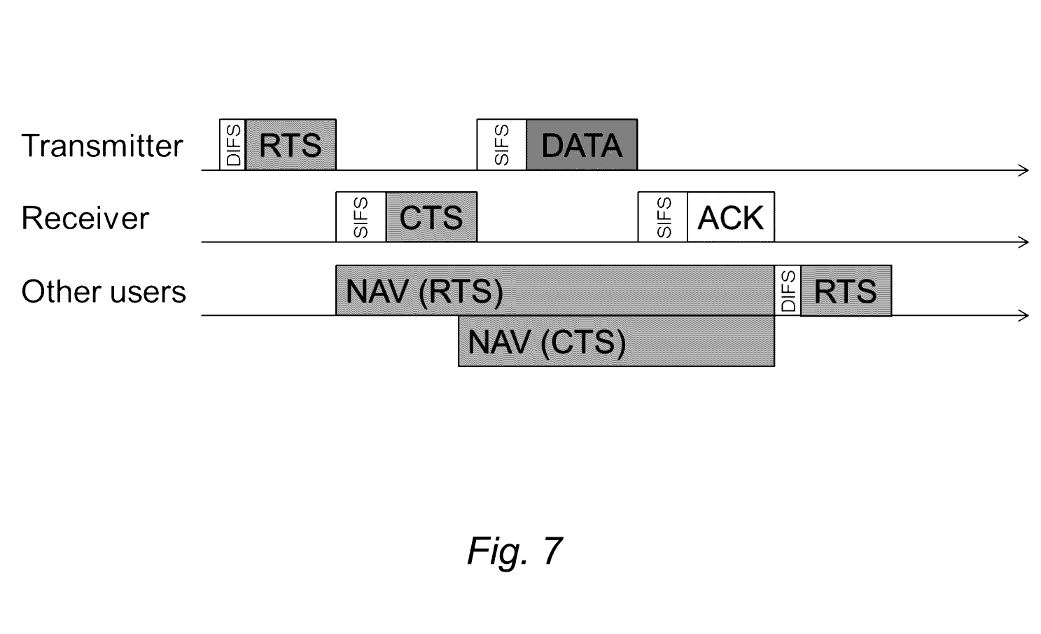

In WLAN systems, the concept of a request-to-send, RTS, and a clear-to-send, CTS, frame exchange between a receiver and a transmitter was introduced to eliminate hidden node problems. In general, a station intending to transmit in UL will send an RTS frame to the AP, which in turn replies with a CTS frame. Nodes not involved in the RTS-CTS frame exchange, but that hear either the RTS or the CTS (or both) will refrain from using the channel during the time period of the upcoming data frame exchange. This time is included in the Network Allocation Vector, NAV, field of both the CTS and the RTS frame. The procedure is schematically illustrated in FIG. 7.

The proposed technology introduces a negative CTS frame, i.e. a signal or message to inform a station that has sent an RTS frame that it is not allowed to transmit. If the access point receiving the RTS would just avoid sending the normal CTS, the station will keep sending RTS frames, and thus occupying the wireless medium and causing interference to neighbor BSS's. The negative CTS frame is a direct way to inform the station requesting access to the medium or channel that it was not granted access. A station receiving a negative CTS frame should refrain from accessing the wireless medium, typically both control type transmissions such as RTS and data type transmissions, for a predefined period of time.

According to the proposed technology, the negative CTS may be introduced in different ways:

### NAV Set to Zero

In the RTS frame or message there is a Network Allocation Vector, NAV, field indicating the length of the upcoming transmission. According to an example, the proposed technology suggests that stations receiving an RTS frame in reply to a CTS frame must check the NAV field, and if NAV is set to zero interpret the CTS as a negative CTS and refrain from accessing the medium or channel for a specified amount of time. This means that the station may neither access the channel with data frames or with a new RTS frame. The time period may be either known before-hand, e.g. defined by the 802.11 standard, or it may be communicated by the AP through control signaling. The control signaling may be sent either when the station first connects to the BSS, or by regular broadcast updates, or by unicast signaling.

### Explicit Negative/Scheduling CTS Frame

According to another example, a new message or signal that differs from the existing CTS message or frame may be introduced that explicitly states that the RTS was not approved. This so-called “Negative CTS frame” or Negative CTS message” can optionally also include a reason code indicating the reason why the RTS was not approved, and/or information about the t_refrain, the countdown-time to when the station may try again with a new RTS.

Optionally, the negative CTS can also be used to inform the station that it may not respond immediately with a data frame, but that it may send the data frame at a later time instant. Then upon the expiration of the timer t_refrain the STA is allowed to transmit its data packet. Thus, the negative CTS message can optionally be considered as a “scheduling CTS message”, since access is denied for a certain time interval and the data transmission is scheduled to take place after or at expiry of the time interval. The scheduling CTS can however still be considered as a negative CTS since it will also be interpreted as a denial of access of the medium, at least for a specified non-zero time interval.

In a particular example, the negative/scheduling CTS could therefore include:
The receiver address (STA address)
Optionally, the count-down time t_refrain, if not preconfigured
Optionally, two information bits defining instructions to:
   send data at expiration of t_refrain (Code 1), or
   send RTC at expiration of t_refrain with different reason codes:
      Reason code 1 (Code 2)
      Reason code 2 (Code 3)
      Reason code 3 (Code 4).

By way of example, the new negative/scheduling CTS frame may be introduced in a backwards compatible way by adding the new information after existing information fields or information elements. A legacy station would then ignore the new information and treat it as a normal CTS frame.

### Other Use Cases for Negative CTS

As indicated, the negative CTS may provide an access point or equivalent network node with a means to deny and/or to schedule (i.e. postpone) UL transmissions. There may be other reasons besides alignment of DL and UL between neighbor BSSs to send a negative CTS frame. Examples include, but are not limited to:

### Quality of Service, QoS

The AP may use negative CTS to prioritize certain types of traffic, e.g. based on the Access Category (AC) of the requested UL traffic.

### System Fairness

The AP may use the negative CTS frame to reach a higher degree of fairness in the system, for instance through declining stations with very good channel conditions in favor of stations with poor channel conditions. The channel conditions of a station may be known through looking at the MCSs used by previous UL transmissions from the station. This may have to be balanced with system throughput, and may also be based on suitable statistics on STA behavior.

The AP may also keep track of fairness Key Performance Indicators, KPIs, for each station, e.g. percentage of air time or amount of data sent over the channel, and use this as decision basis for whether to deny some access requests from stations.

The AP may also use negative CTS frames to manage the degree or fraction of channel time used for DL and UL transmissions.

As already described, the medium access decision may depend at least partly on whether the amount of data in a data buffer for downlink transmissions exceeds a threshold, to enable fairness between uplink and downlink transmissions. Alternatively, the medium access decision may depend at least partly on whether the wireless communication device has a higher usage of the radio medium than other wireless communication device(s), to enable fairness between different wireless communication devices for uplink transmissions.

### Interference Knowledge

The AP may have information about the current and upcoming interference situation in the system. This information may be obtained from exchanging information with neighbor BSSs over some interface or it may be received from a central node in the network. It may also be the case that the AP simply measures the amount of interference it experiences, or the amount of failed receptions, and determines it is in a high interference period. The length of such periods may also be statistically estimated.

An example may be that the AP will know that the UL transmission that was requested by a station through an RTS is very likely to fail, and the AP may thus send a negative CTS frame to keep the medium free for an UL transmission from another station, or for a DL transmission.

The negative CTS frame is a direct way to inform the station requesting access to the medium or channel that it should refrain from accessing the wireless medium, typically both control type transmissions such as RTS and data type transmissions, for a specified, e.g. preconfigured or communicated, period of time.

Reference [1] relates to a method for reducing the occurrence of masked nodes in a communication network involving the use of Invalid-To-Receive, ITR, messages, and introducing a negative Clear-To-Send, CTS message in response to an ITR for the purpose of cancelling a previously established transmission, or for preventing, in response to an ITR, a node from sending data messages.

The proposed technology differs from the solution of reference [1] in at least two distinct ways. First, according to the proposed technology, a medium access decision is taken in response to an RTS message from the wireless device. Secondly, if access to the radio medium is denied, a negative CTS is sent to instruct the wireless device to temporarily refrain from accessing the radio medium for transmission during a specified time interval.

Reference [2] relates to a method for frame transmission in a WLAN system, where an access point receives a single OFDM symbol from each of a plurality of stations, STAs, and a single-tone Request-To-Send, sRTS through a single subcarrier, and selects STAs for performing uplink multiuser multiple input multiple output transmission, and transmits to the plurality of STAs a single-tone Clear-To-Send, sCTS, frame allocated to the same subcarrier as a subcarrier to which the sRTS frames received from selected STAs are allocated. The access point also has the possibility to transmit a negative CTS frame indicating whether a collision occurs or not, to the STAs. In this case, the last subcarrier of a single tone frame may be used to identify the nCTS frame. STAs that have received the nCTS frame randomly determine tones and transmit a first sRTS frame, a second sRTS frame and a third sRTS frame, respectively, to the access point. This process is repeated until a collision does not occur.

Reference [3] relates to a method of controlling interference between communication terminals involving sending a notification of a desire to transmit a transmission over a wireless network from a first terminal, determining whether any terminal has sent an objection in response to the notification, and sending the transmission if no objection is received and modifying the transmission if an objection is received. A terminal station sends a request, REQ, and the intended destination station sends a so-called REP message indicating that it has heard the request together with information on the power needed to reach the destination. Other stations in the area also listens to the REQ and if it causes them interference, they may send back a not Clear-To-Send, NCTS, message containing information about the maximum power that the originator is allowed to transmit without causing unacceptable interference.

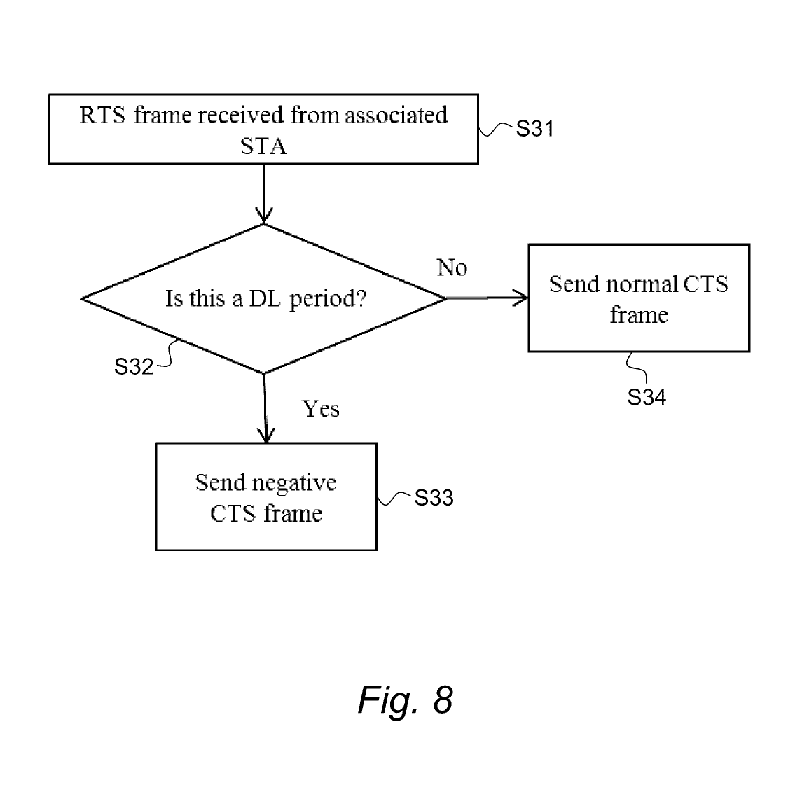

FIG. 8 is a schematic flow diagram illustrating a non-limiting example of a method for controlling access to a radio medium from the network side according to a specific embodiment. This embodiment specifically relates to the use case of aligning UL and DL periods between neighbor BSSs through negative CTS. In step S31, an RTS message or frame is received from an associated STA. In step S32, the AP or equivalent network node investigates or checks whether the RTS is received during a DL period. The AP should preferably keep a timer to keep track of when a DL period starts and ends. During such a DL period (Yes), the AP will reply to RTS frames by sending a negative CTS frame, as indicated in step S33. If the RTS is not received during a DL period (No), the AP will send a normal CTS frame.

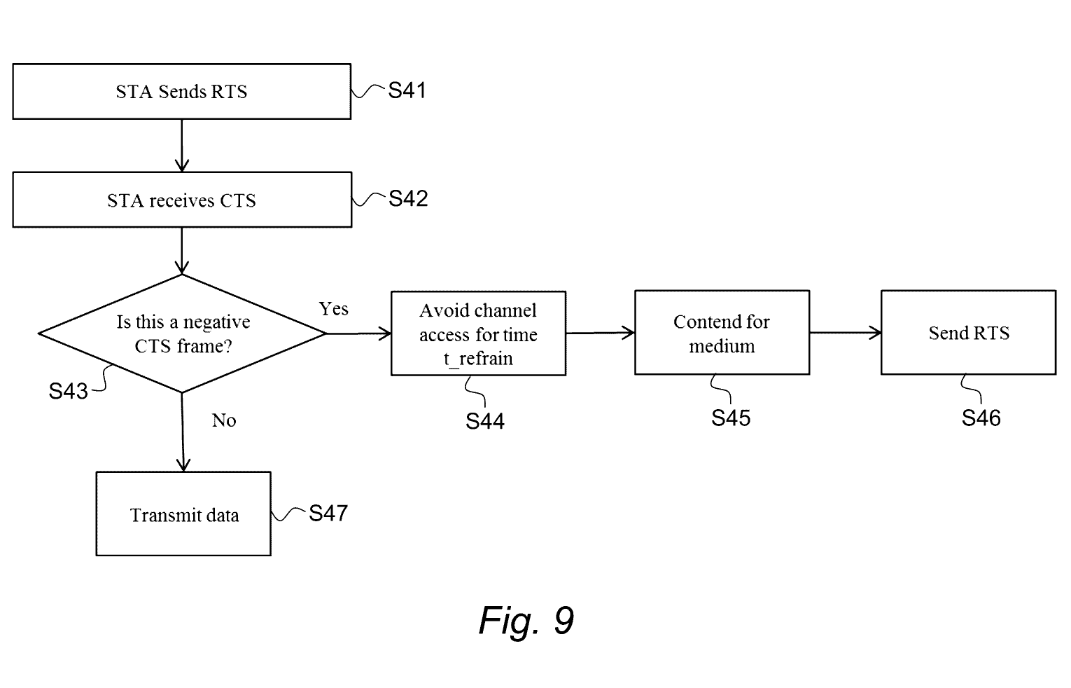

FIG. 9 is a schematic flow diagram illustrating a non-limiting example of a method for controlling access to a radio medium from the terminal side according to a specific embodiment. The overall procedure is initiated in step S41 in that the STA sends an RTS, upon sensing that the medium is free. In step S42, the STA receives a CTS/nCTS from the AP. In step S43, the STA checks whether a negative CTS frame, i.e. a nCTS, is received. Upon reception of a negative CTS frame (Yes), the STA will refrain from further transmission attempts during a predetermined or communicated time interval, t_refrain, as indicated in step S44. After this interval the station will either contend for medium, as indicated in step S45, and then send a new RTS after sensing that the medium is free, as indicated in step S46. Alternatively, the STA may transmit the UL data frame(s) after expiry of the time interval, t_refrain. If there is no negative CTS frame (No) and the received control frame is a normal CTS, data is transmitted accordingly without further delay, as indicated in step S47.

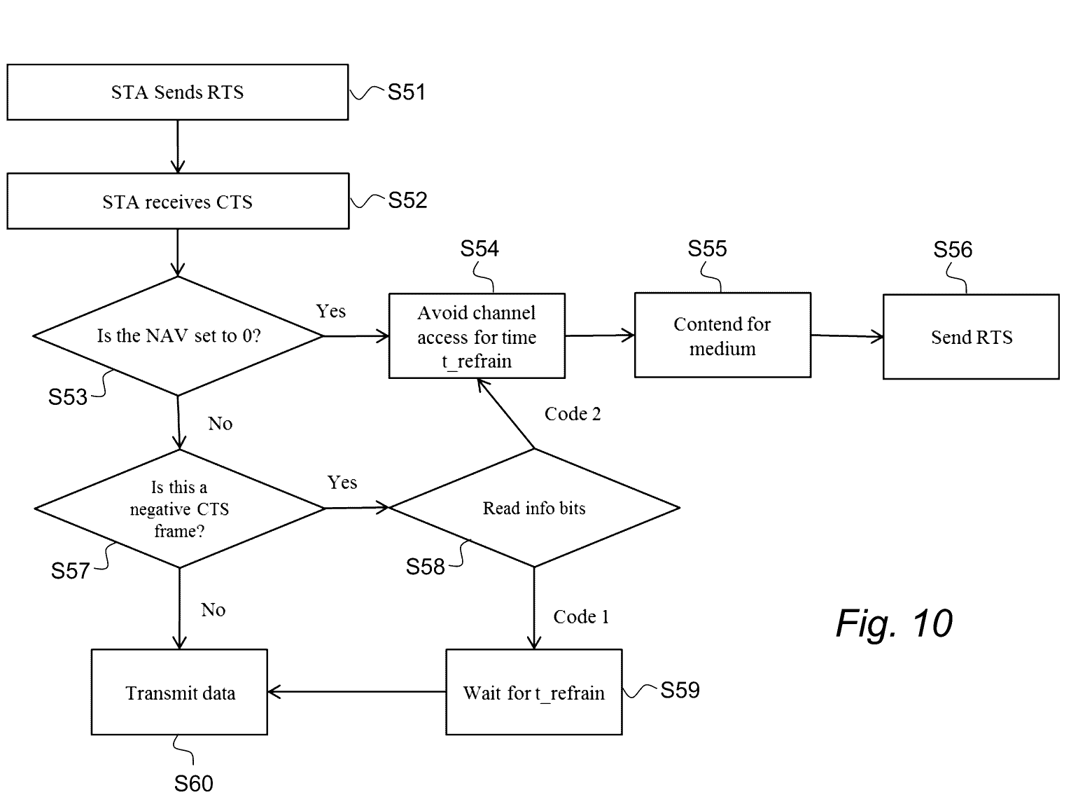

FIG. 10 is a schematic flow diagram illustrating a non-limiting example of a method for controlling access to a radio medium from the terminal side according to another specific embodiment. The overall procedure is initiated in step S51 in that the STA sends an RTS, upon sensing that the medium is free. In step S52, the STA receives a CTS/nCTS from the AP. In step S53, the STA checks whether the message is a CTS with the NAV set to zero, which is one way of checking whether a negative CTS has been received. If a CTS with NAV set to zero is received (Yes), the STA will refrain from further transmission attempts during a predetermined or communicated time interval, t_refrain, as indicated in step S54. After this interval the station will contend for medium, as indicated in step S55, and then send a new RTS after sensing that the medium is free, as indicated in step S56. If no CTS with NAV set to zero is received in step S53 (No), then the STA checks, in step S57, whether an explicit negative CTS frame, i.e. a nCTS, is received. If a nCTS is received (Yes), it may be possible to read the optional information bits included with the nCTS frame. If the information bits correspond to Code 2, as defined above, steps S54-S56 are performed. If the information bits correspond to Code 1, as defined above, the STA waits for the refrain time interval to expire, as indicated in step S59, and then transmits the data in step S60. If the there is no negative CTS frame (No), and the received control frame is a normal CTS, data is transmitted accordingly without further delay, as indicated in step S60. The order of steps may be changed, e.g. steps S53 and S57 in FIG. 10.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits, ASICs.

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors, DSPs, one or more Central Processing Units, CPUs, video acceleration hardware, and/or any suitable programmable logic circuitry such as one or more Field Programmable Gate Arrays, FPGAs, or one or more Programmable Logic Controllers, PLCs.

It should also be understood that it may be possible to re-use the general processing capabilities of any conventional device or unit in which the proposed technology is implemented. It may also be possible to re-use existing software, e.g. by reprogramming of the existing software or by adding new software components.

As used herein, the non-limiting term “network node” may refer to access points, base stations, network control nodes such as network controllers, access controllers, radio network controllers, base station controllers, and the like.

As used herein, the non-limiting terms “wireless communication device”, “wireless device” and “station” or “terminal” may refer to a mobile phone, a cellular phone, a Personal Digital Assistant, PDA, equipped with radio communication capabilities, a smart phone, a laptop or Personal Computer, PC, equipped with an internal or external mobile broadband modem, a tablet PC with radio communication capabilities, a target device, User Equipment, UE, a device to device UE, a machine type UE or UE capable of machine to machine communication, iPAD, customer premises equipment, CPE, laptop embedded equipment, LEE, laptop mounted equipment, LME, USB dongle, a portable electronic radio communication device, a sensor device equipped with radio communication capabilities or the like. In particular, the term “wireless communication device” should be interpreted as non-limiting terms comprising any type of wireless device communicating with a radio network node in a wireless communication system or any device equipped with radio circuitry for wireless communication according to any relevant standard for communication.

The proposed technology also provides an arrangement configured to control access to a radio medium. The arrangement is configured to decide, in response to a Request-To-Send, RTS, message from a wireless communication device, whether the wireless communication device is to be allowed or denied access for transmission on the radio medium. The arrangement is further configured to send, if access to the radio medium is denied, a negative Clear-To-Send, CTS, message to the wireless communication device instructing the wireless communication device to temporarily refrain from accessing the radio medium for transmission during a refrain time interval.

Optionally, the arrangement may be configured to send the negative CTS message including information about the duration of refrain time interval.

By way of example, the arrangement may optionally be configured to send the negative CTS message including information representing a reason for denying access for transmission on the radio medium and/or information of when and how the wireless device may access the channel.

As an example, the arrangement may be configured to send the negative CTS message including information instructing the wireless communication device to perform an uplink data transmission at expiration of the refrain time interval.

In a particular example, the arrangement is configured to represent the negative CTS message by a CTS message with the Network Allocation Vector, NAV, field set to zero.

By way of example, for a particular use case, the arrangement may be configured to decide whether the wireless communication device is to be allowed or denied access for transmission on the radio medium based on determining whether the RTS message is received during a downlink transmission time period. For example, the downlink transmission time period is dedicated for downlink transmissions by at least one access point, and access to the radio medium for transmission by the wireless communication device is denied during the downlink transmission time period.

Typically, the downlink transmission time period is common for at least two neighboring access points.

By way of example, the arrangement may be configured to decide whether the wireless communication device is to be allowed or denied access for transmission on the radio medium based on information about dedicated downlink transmission period(s), traffic type information, fairness information and/or interference information, as previously explained.

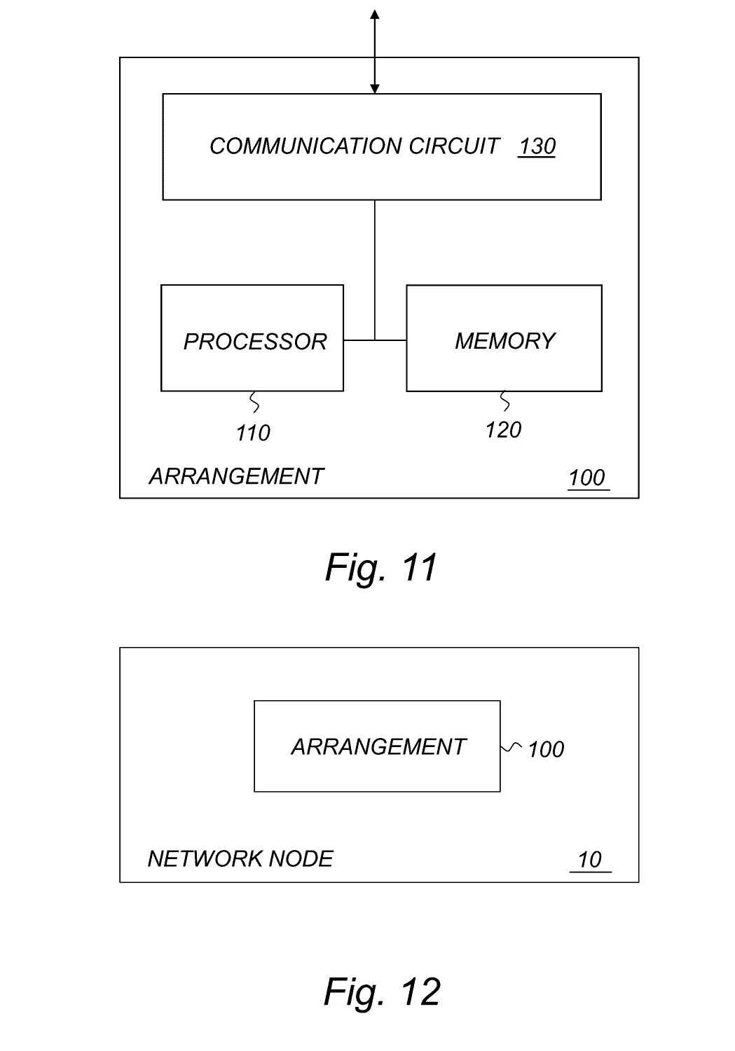

FIG. 11 is a schematic block diagram illustrating an example of an arrangement configured to control access to a radio medium according to an embodiment. In this particular example, the arrangement 100 comprises a processor 110 and a memory 120, the memory 120 comprising instructions executable by the processor 110, whereby the processor 110 is operative to control access to the radio medium, as described herein.

Optionally, the arrangement 100 may also include a communication circuit 130. The communication circuit 130 may include functions for wired and/or wireless communication with other devices and/or network nodes in the network. In a particular example, the communication circuit 130 may be based on radio circuitry for communication with one or more other nodes, including transmitting and/or receiving information. The communication circuit 130 may be interconnected to the processor 110 and/or memory 120.

FIG. 12 is a schematic diagram illustrating an example of a network node comprising an arrangement of FIG. 11. The network node 10 comprises an arrangement 100 as described herein. By way of example, the network node 10 is an access point.

In a particular example, the network node 10 is configured to provide access to the radio medium for downlink transmissions in dedicated downlink transmission time period(s) and for uplink transmissions in dedicated uplink transmission time period(s). The network node 10 is further configured to send, in response to a Request-To-Send, RTS, message received from a wireless communication device during a downlink transmission time period, a negative Clear-To-Send, CTS, message to the wireless communication device instructing the wireless communication device to refrain from accessing the radio medium for transmission during a time interval lasting at least until the expiration of the downlink transmission time period.

The proposed technology also provides an arrangement configured to control access to a radio medium. The arrangement is configured to receive, in response to a Request-To-Send, RTS, message, a negative Clear-To-Send, CTS, message from an access point. The arrangement is also configured to temporarily refrain, in response to the negative CTS message, from accessing the radio medium for transmission during a refrain time interval.

Optionally, the arrangement is configured to receive a negative CTS message including information about the duration of the refrain time interval.

By way of example, the arrangement may be configured to receive a negative CTS message including information representing a reason for denying access for transmission on the radio medium and/or information of when and how the wireless device may access the channel.

For example the arrangement may be configured to receive a negative CTS message including information instructing the wireless communication device to perform an uplink data transmission at expiration of the refrain time interval, and the arrangement is configured to perform the uplink data transmission at expiration of the refrain time interval.

In a particular example, the arrangement is configured to receive a negative CTS message represented by a CTS message with the Network Allocation Vector, NAV, field set to zero.

As an example, the arrangement may be configured to temporarily refrain from accessing the radio medium for transmission until the expiration of a downlink transmission time period dedicated for downlink transmissions by at least one access point.

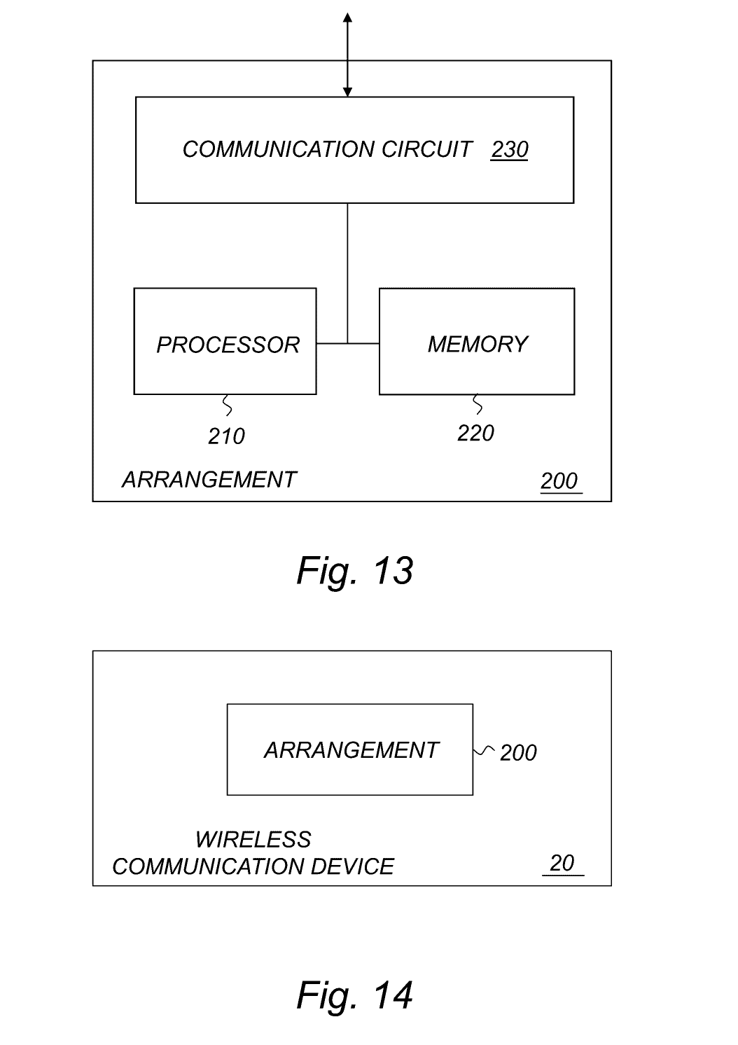

FIG. 13 is a schematic block diagram illustrating an example of an arrangement configured to control access to a radio medium according to another embodiment. In this particular example, the arrangement 200 comprises a processor 210 and a memory 220, the memory 220 comprising instructions executable by the processor 210, whereby the processor 210 is operative to control access to the radio medium, as described herein.

Optionally, the arrangement 200 may also include a communication circuit 230. The communication circuit 230 may include functions for wireless communication with other devices and/or network nodes in the network. In a particular example, the communication circuit 230 may be based on radio circuitry for communication with one or more other nodes, including transmitting and/or receiving information. The communication circuit 230 may be interconnected to the processor 210 and/or memory 220.

FIG. 14 is a schematic diagram illustrating an example of a wireless communication device comprising an arrangement of FIG. 13. The wireless communication device 20 comprises an arrangement 200 as described herein.

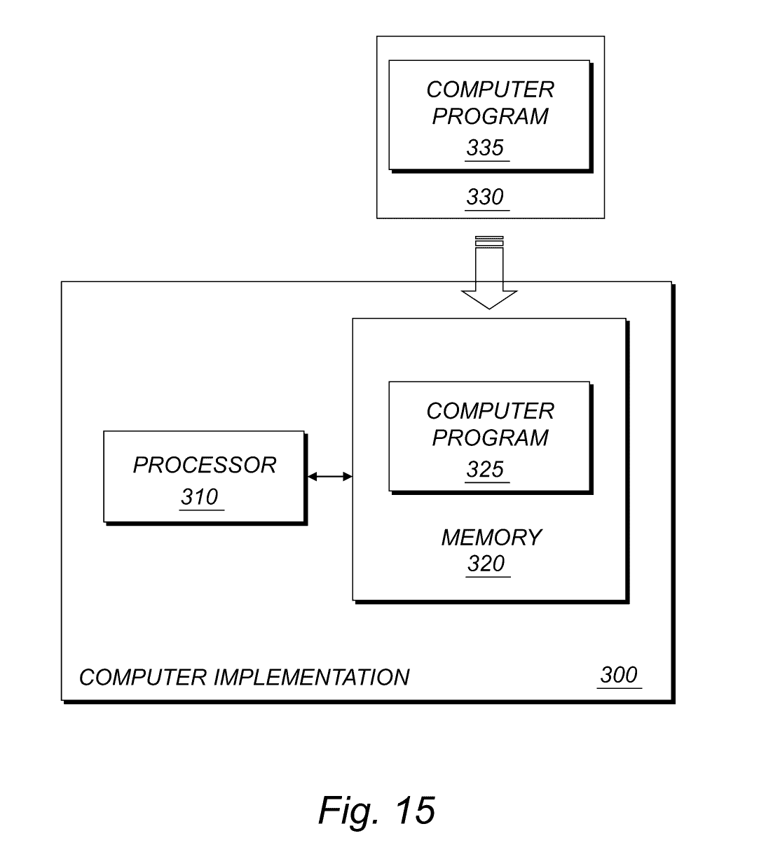

FIG. 15 is a schematic diagram illustrating an example of a computer implementation according to an embodiment.

In this particular example, at least some of the steps, functions, procedures, modules and/or blocks described herein are implemented in a computer program 335; 325, which is loaded into the memory 320 for execution by processing circuitry including one or more processors 310. The processor(s) 310 and memory 320 are interconnected to each other to enable normal software execution. An optional input/output device may also be interconnected to the processor(s) and/or the memory to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

In a particular embodiment, the computer program 325; 335 comprises instructions, which when executed by at least one processor, cause the processor(s) to:
decide, in response to a Request-To-Send, RTS, message originating from a wireless communication device, whether the wireless communication device is to be allowed or denied access for transmission on a radio medium; and
generate, if access to the radio medium is denied, a negative Clear-To-Send, CTS, message for sending to the wireless communication device instructing the wireless communication device to temporarily refrain from accessing the radio medium for transmission during a refrain time interval.

In another particular embodiment, the computer program 325; 335 comprises instructions, which when executed by at least one processor, cause the processor(s) to:
read a negative Clear-To-Send, CTS, message originating from an access point; and
instruct, in response to the negative CTS message, a communication unit to temporarily refrain from accessing the radio medium for transmission during a refrain time interval.

In yet another particular embodiment, the computer program 325; 335 comprises instructions, which when executed by at least one processor, cause the processor(s) to:
control access to the radio medium for downlink transmissions in dedicated downlink transmission time period(s) and for uplink transmissions in dedicated uplink transmission time period(s);
generate, in response to a Request-To-Send, RTS, message received from a wireless communication device during a downlink transmission time period, a negative Clear-To-Send, CTS, message for transmission to the wireless communication device instructing the wireless communication device to refrain from accessing the radio medium for transmission during a time interval lasting at least until the expiration of the downlink transmission time period.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

By way of example, the software or computer program 325; 335 may be realized as a computer program product, which is normally carried or stored on a computer-readable medium 320; 330, in particular a non-volatile medium. The computer-readable medium may include one or more removable or non-removable memory devices including, but not limited to a Read-Only Memory, ROM, a Random Access Memory, RAM, a Compact Disc, CD, a Digital Versatile Disc, DVD, a Blu-ray disc, a Universal Serial Bus, USB, memory, a Hard Disk Drive, HDD, storage device, a flash memory, a magnetic tape, or any other conventional memory device. The computer program 325; 335 may thus be loaded into the operating memory 320 of a computer or equivalent processing device for execution by the processing circuitry thereof.

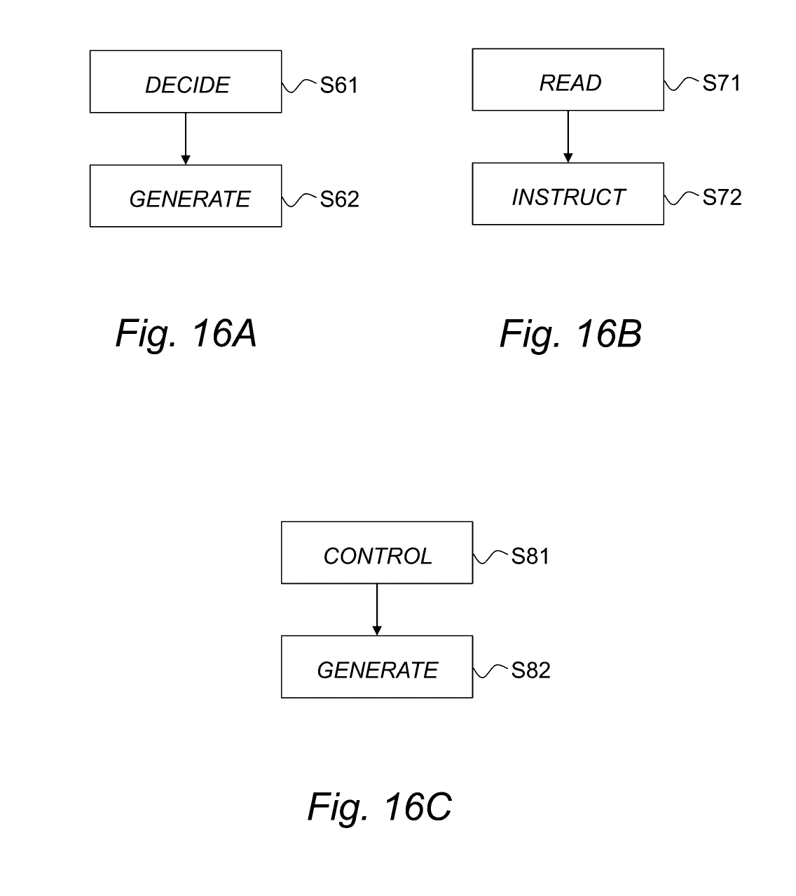

FIGS. 16A-C are schematic computer flow diagrams illustrating examples of respective series of computer-implemented actions.

In the example of FIG. 16A, the processor is caused to decide, in response to an RTS, whether the corresponding wireless communication device is to be allowed or denied access for transmission on a radio medium, as indicated in Step S61, and the processor is then caused to generate, if access to the radio medium is denied, a negative Clear-To-Send, CTS, message for sending to the wireless communication device, as indicated in Step S62.

In the example of FIG. 16B, the processor is caused to read a negative Clear-To-Send, CTS, message originating from an access point, as indicated in step S71, and then the processor is caused to instruct, in response to the negative CTS message, a communication unit to temporarily refrain from accessing the radio medium for transmission during a refrain time interval, as indicated in step S72.

In the example of FIG. 16C, the processor is caused to control access to the radio medium for downlink transmissions in dedicated downlink transmission time period(s) and for uplink transmissions in dedicated uplink transmission time period(s), as indicated in step S81. The processor is also caused to generate, in response to an RTS received from a wireless communication device during a downlink transmission time period, a negative CTS for transmission to the wireless communication device instructing the wireless communication device to refrain from accessing the radio medium for transmission during a time interval lasting at least until the expiration of the downlink transmission time period.

The flow diagrams presented herein may be regarded as computer flow diagrams, when performed by one or more processors. A corresponding apparatus may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

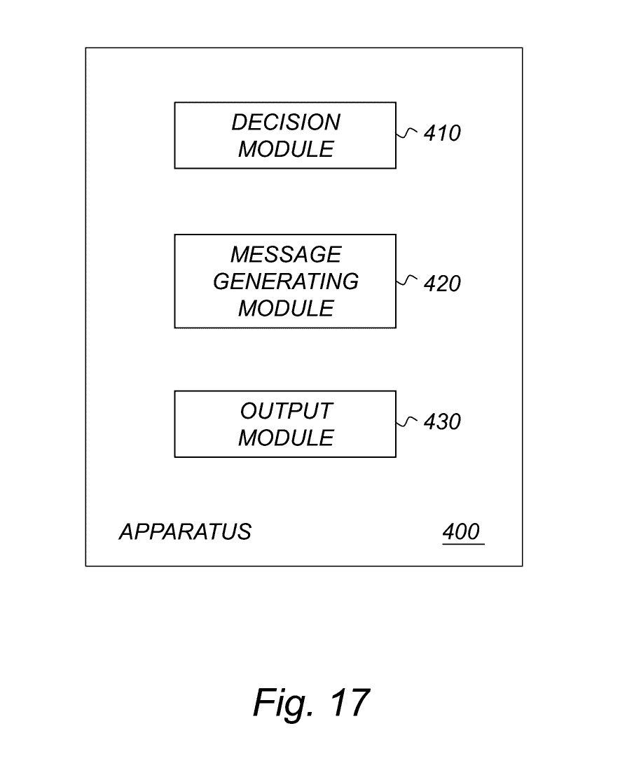

FIG. 17 is a schematic diagram illustrating an example of an apparatus for controlling access to a radio medium according to an embodiment. The apparatus 400 comprises a decision module 410 for deciding, in response to a Request-To-Send, RTS, message originating from a wireless communication device, whether the wireless communication device is to be allowed or denied access for transmission on a radio medium. The apparatus 400 also comprises a message generating module 420 for generating, if access to the radio medium is denied, a negative Clear-To-Send, CTS, message. The apparatus 400 further comprises an output module 430 for outputting the negative CTS message for transmission to the wireless communication device instructing the wireless communication device to temporarily refrain from accessing the radio medium for transmission during a refrain time interval.

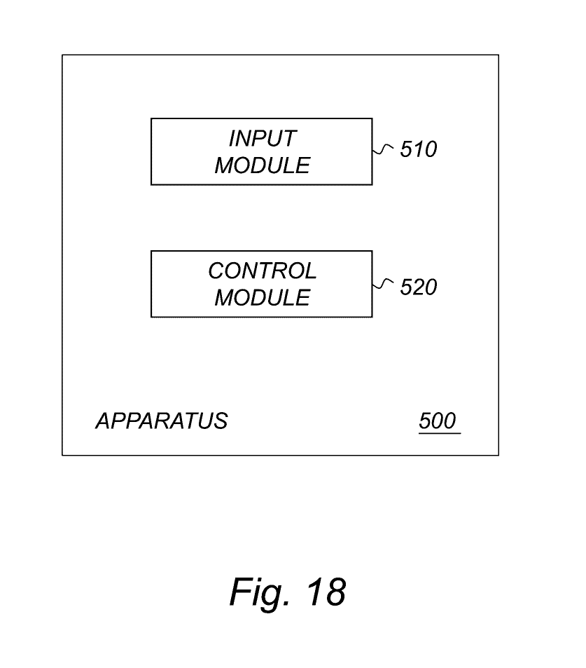

FIG. 18 is a schematic diagram illustrating an example of an apparatus for controlling access to a radio medium according to another embodiment. The apparatus 500 comprises an input module 510 for reading a negative Clear-To-Send, CTS, message originating from an access point. The apparatus 500 also comprises a control module 520 for instructing, in response to the negative CTS message, a communication unit to temporarily refrain from accessing the radio medium for transmission during a refrain time interval.

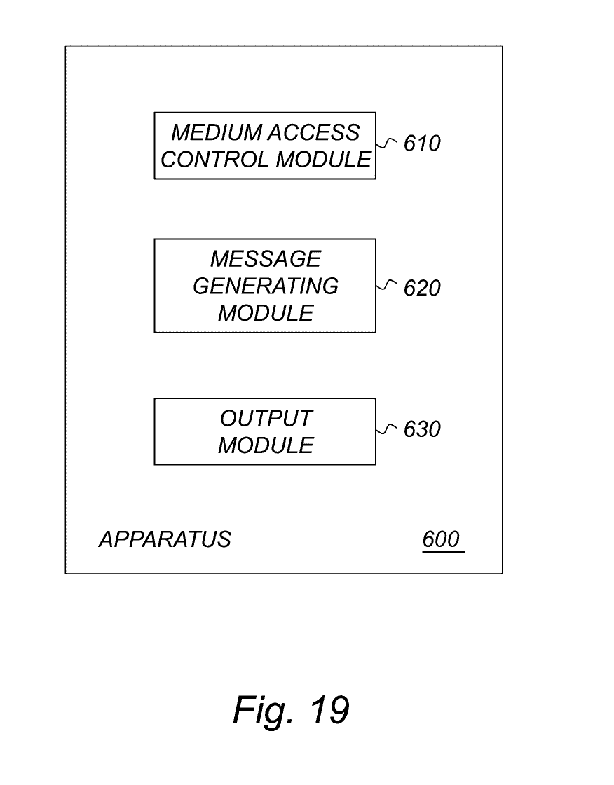

FIG. 19 is a schematic diagram illustrating an example of an apparatus for controlling access to a radio medium according to yet another embodiment. The apparatus 600 comprises a medium access control module 610 for controlling access to the radio medium for downlink transmissions in dedicated downlink transmission time period(s) and for uplink transmissions in dedicated uplink transmission time period(s). The apparatus 600 also comprises a message generating module 620 for generating, in response to a Request-To-Send, RTS, message received from a wireless communication device during a downlink transmission time period, a negative Clear-To-Send, CTS, message. The apparatus 600 further comprises an output module 630 for outputting the negative CTS message for transmission to the wireless communication device instructing the wireless communication device to refrain from accessing the radio medium for transmission during a time interval lasting at least until the expiration of the downlink transmission time period.

Alternatively it is possibly to realize the modules in FIGS. 17 to 19 predominantly by hardware modules, or alternatively by hardware, with suitable interconnections between relevant modules. Particular examples include one or more suitably configured digital signal processors and other known electronic circuits, e.g. discrete logic gates interconnected to perform a specialized function, and/or Application Specific Integrated Circuits, ASICs, as previously mentioned. Other examples of usable hardware include input/output, I/O, circuitry and/or circuitry for receiving and/or sending signals. The extent of software versus hardware is purely implementation selection.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

### REFERENCES

[1] US Patent Application Publication 2011/0255442

[2] US Patent Application Publication 2014/301383

[3] US Patent Application Publication 2009/304047

1-50. (canceled)

51. A method, in a network node, for controlling access to a radio medium, the method comprising:
deciding, in response to a Request-To-Send (RTS) message from a wireless communication device, whether the wireless communication device is to be allowed or denied access for transmission on the radio medium; and
sending, in response to deciding that access to the radio medium by the wireless communication device is denied, a negative Clear-To-Send (CTS) message to the wireless communication device instructing the wireless communication device to temporarily refrain from accessing the radio medium for transmission during a refrain time interval.

52. The method of claim 51, wherein the negative CTS message includes one or both of:
information about the duration of refrain time interval;
information representing a reason for denying access for transmission on the radio medium; and
information of when and how the wireless communication device may access the channel.

53. The method of claim 51, wherein the negative CTS message includes information instructing the wireless communication device to contend for the medium and send a new RTS message after expiration of the refrain time interval.

54. The method of claim 51, wherein the negative CTS message includes information instructing the wireless communication device to perform an uplink data transmission at expiration of the refrain time interval.

55. The method of claim 51, wherein the negative CTS message is a CTS message with a Network Allocation Vector (NAV) field set to zero.

56. The method of claim 51, wherein deciding whether the wireless communication device is to be allowed or denied access for transmission on the radio medium is based on determining whether the RTS message is received during a downlink transmission time period, wherein the downlink transmission time period is dedicated for downlink transmissions by at least one access point, and access to the radio medium for transmission by the wireless communication device is denied during the downlink transmission time period.

57. The method of claim 56, further comprising negotiating the downlink transmission time period with another network node.

58. The method of claim 56, wherein the refrain time interval is a count-down time lasting until the expiration of the downlink transmission time period.

59. The method of claim 51, wherein deciding whether the wireless communication device is to be allowed or denied access for transmission on the radio medium is based on at least one of the following:
information about dedicated downlink transmission period(s);
information on the traffic type of the transmission;
fairness information; and
information about the interference situation in the area of the wireless communication device.

60. The method of claim 51, wherein deciding whether the wireless communication device is to be allowed or denied access for transmission depends at least partly on whether the amount of data in a data buffer for downlink transmissions exceeds a threshold, to enable fairness between uplink and downlink transmissions.

61. The method of claim 51, wherein deciding whether the wireless communication device is to be allowed or denied access for transmission depends at least partly on whether the wireless communication device has a higher usage of the radio medium than other wireless communication device(s), to enable fairness between different wireless communication devices for uplink transmissions.

62. The method of claim 51, wherein the network node is an access point.

63. A method, in a wireless communication device, for managing access to a radio medium, the method comprising:
receiving, in response to a Request-To-Send (RTS) message, a negative Clear-To-Send (CTS) message from an access point; and
temporarily refraining, in response to the negative CTS message, from accessing the radio medium for transmission during a refrain time interval.

64. The method of claim 63, wherein the negative CTS message includes one or more:
information about the duration of the refrain time interval;
information representing a reason for denying access for transmission on the radio medium; and
information of when and how the wireless communication device may access the channel.

65. The method of claim 63, wherein the negative CTS message includes information instructing the wireless communication device to contend for the medium and send a new RTS message after expiration of the refrain time interval, and wherein the method further comprises the steps of contending for the medium and sending a new RTS message after expiration of the refrain time interval.

66. The method of claim 63, wherein the negative CTS message includes information instructing the wireless communication device to perform an uplink data transmission at expiration of the refrain time interval, and the method further comprises the step of performing the uplink data transmission at expiration of the refrain time interval.

67. The method of claim 63, wherein the negative CTS message comprises a CTS message with a Network Allocation Vector (NAV) field set to zero.

68. A network node configured to control access to a radio medium, the network node comprising a processor and a memory, said memory comprising computer program instructions executable by the processor, wherein the computer program instructions are arranged so that, when the computer program instructions are executed by the processor, the computer program instructions cause the network node to:
decide, in response to a Request-To-Send (RTS) message from a wireless communication device, whether the wireless communication device is to be allowed or denied access for transmission on the radio medium; and
send, in response to deciding that access to the radio medium by the wireless communication device is denied, a negative Clear-To-Send (CTS) message to the wireless communication device instructing the wireless communication device to temporarily refrain from accessing the radio medium for transmission during a refrain time interval.

69. The network node of claim 68, wherein the computer program instructions are further arranged to cause the network node to include, in the negative CTS message, one or more of:
information about the duration of refrain time interval;
information representing a reason for denying access for transmission on the radio medium; and
information of when and how the wireless communication device may access the channel.

70. The network node of claim 68, wherein the computer program instructions are further arranged to cause the network node to include, in the negative CTS message, information instructing the wireless communication device to perform an uplink data transmission at expiration of the refrain time interval.

71. The network node of claim 68, wherein the negative CTS message comprises a CTS message with a Network Allocation Vector (NAV) field set to zero.

72. The network node of claim 68, wherein the computer program instructions are further arranged to cause the network node to decide whether the wireless communication device is to be allowed or denied access for transmission on the radio medium based on determining whether the RTS message is received during a downlink transmission time period, wherein the downlink transmission time period is dedicated for downlink transmissions by at least one access point, and access to the radio medium for transmission by the wireless communication device is denied during the downlink transmission time period.

73. The network node of claim 72, wherein the computer program instructions are further arranged to cause the network node to negotiate the downlink transmission time period with another network node.

74. The network node of claim 68, wherein the computer program instructions are further arranged to cause the network node to decide whether the wireless communication device is to be allowed or denied access for transmission on the radio medium based on information about dedicated downlink transmission period(s), traffic type information, fairness information and/or interference information.

75. A wireless communication device configured to manage access to a radio medium, the wireless communication device comprising a processor and a memory, said memory comprising computer program instructions executable by the processor, wherein the computer program instructions are arranged so that, when the computer program instructions are executed by the processor, the computer program instructions cause the wireless communication device to:
receive, in response to a Request-To-Send (RTS) message, a negative Clear-To-Send (CTS) message from an access point; and
temporarily refrain, in response to the negative CTS message, from accessing the radio medium for transmission during a refrain time interval.

76. The wireless communication device of claim 75, wherein the wireless communication device is configured to receive a negative CTS message including information about the duration of the refrain time interval.

77. The wireless communication device of claim 75, wherein the wireless communication device is configured to receive a negative CTS message including information representing a reason for denying access for transmission on the radio medium and/or information of when and how the wireless device may access the channel.

78. The wireless communication device of claim 75, wherein the wireless communication device is configured to receive a negative CTS message including information instructing the wireless communication device to perform an uplink data transmission at expiration of the refrain time interval, and the wireless communication device is configured to perform the uplink data transmission at expiration of the refrain time interval.

79. The wireless communication device of claim 75, wherein the wireless communication device is configured to receive a negative CTS message represented by a CTS message with the Network Allocation Vector (NAV) field set to zero.

80. The wireless communication device of claim 75, wherein the wireless communication device is configured to temporarily refrain from accessing the radio medium for transmission until the expiration of a downlink transmission time period dedicated for downlink transmissions by at least one access point.
